(19) United States
(12) Patent Application Publication
(10) Pub. No.: US 2021/0147244 A1
(43) Pub. Date: May 20, 2021

(54) SILICA AEROGEL POWDER, PREPARATION METHOD AND APPLICATION THEREOF

(71) Applicant: Jilin Jianzhu University, Changchun (CN)

(72) Inventors: Hongkai ZHAO, Changchun (CN); Wei LIU, Changchun (CN); Lihua ZHANG, Changchun (CN); Ming LIU, Changchun (CN); Yifu LIU, Changchun (CN)

(21) Appl. No.: 16/776,580

(22) Filed: Jan. 30, 2020

(30) Foreign Application Priority Data
Nov. 19, 2019 (CN) 201911132357.4

(51) Int. Cl. C01B 33/158; B01J 13/00; C01B 33/145

(52) U.S. Cl. CPC C01B 33/1585; C01B 33/145; B01J 13/0091

(57) ABSTRACT

The present invention provides a silica aerogel powder, a preparation method and an application thereof, and belongs to the field of preparation of insulating materials. The silica aerogel powder provided by the present invention is prepared from the following components: 100 to 300 parts by weight of aqueous solution of silica source, 200 to 400 parts by weight of oil phase solvent, 4 to 40 parts by weight of cosolvent, 0.2 to 2 parts by weight of surfactant, 10 to 60 parts by weight of sodium methylsiliconate solution, 1 to 5 parts by weight of aqueous inorganic acid solution, 3 to 10 parts by weight of sodium trimethylsilanolate solution in tetrahydrofuran (THF), and 0.3 to 0.9 part by weight of organic fatty acid in petroleum ether. The silica aerogel powder provided by the present invention is structurally uniform and features good hydrophobicity, low thermal conductivity, and low density.

### CROSS-REFERENCE TO RELATED APPLICATIONS

This application claims priority to Chinese Patent Application No. 201911132357.4 filed on Nov. 19, 2019, the entire contents of which is hereby incorporated by reference.

### TECHNICAL FIELD

The present invention relates to the technical field of preparation of insulating materials, and in particular to a silica aerogel powder, a preparation method and an application thereof.

### BACKGROUND

Silica (SiO₂) aerogel is a novel lightweight porous material formed by mutual aggregation of nano-particles and with air as dispersion medium, and is mainly used as thermal insulation and acoustic materials. Aerogels prepared with high-purity silicon alkoxide (e.g., tetraethoxysilane) as silica source have excellent performance in all aspects, but require a high cost. Therefore, they are not suitable for popularization in the civilian field, such as building insulation.

So far, tetramethoxysilane and tetraethoxysilane are used as silica sources in most of aerogel preparation technologies in China and overseas, where nanoscale silica aerogel is prepared under conditions of supercritical drying process. However, such preparation method features a complex process, high technological requirement, time consumption, and high cost, seriously limiting the commercial development of silica aerogel production technology.

In the prior art, SiO₂ aerogel is often prepared by drying under normal pressure; however, limited by the limitation of ambient drying technology, the structure, hydrophobicity, low thermal conductivity, and low density of the SiO₂ aerogel prepared by drying under normal pressure are poor, far inferior to those of the SiO₂ aerogel prepared by drying under supercritical condition. These factors limit the further development of SiO₂ aerogel, making industrial production of SiO₂ impossible.

### SUMMARY

In view of this, an objective of the present invention is to provide a silica aerogel powder, a preparation method and an application thereof. The silica aerogel powder provided by the present invention is structurally uniform and features good hydrophobicity, low thermal conductivity, and low density.

To achieve the above purpose, the present invention provides the following technical solution:

The present invention provides a silica aerogel powder, where the powder is prepared from the following components:

100 to 300 parts by weight of aqueous solution of silica source, 200 to 400 parts by weight of oil phase solvent, 4 to 40 parts by weight of cosolvent, 0.2 to 2 parts by weight of surfactant, 10 to 60 parts by weight of sodium methylsiliconate solution, 1 to 5 parts by weight of aqueous inorganic acid solution, 3 to 10 parts by weight of sodium trimethylsilanolate solution in tetrahydrofuran (THF), and 0.3 to 0.9 part by weight of organic fatty acid in petroleum ether.

Preferably, a mass concentration of the sodium methylsiliconate solution is 28%-32%.

Preferably, a mass concentration of the sodium trimethylsilanolate solution in THF is 8%-12%.

Preferably, a molar concentration of the organic fatty acid in petroleum ether is 0.01-0.015 mol/L.

Preferably, the organic fatty acid from the organic fatty acid in petroleum ether includes one or more of C₈₋₁₈ fatty acids.

Preferably, a mass concentration of SiO₂ in the aqueous solution of silica source is 5%-8%.

Preferably, a molar concentration of the aqueous inorganic acid solution is 0.01-0.015 mol/L.

Preferably, the oil phase solvent includes hydrocarbon solvent, halohydrocarbon, or esters.

The present invention further provides a preparation method of the above-described silica aerogel powder, including the following steps:

mixing and heating aqueous solution of silica source, surfactant, oil phase solvent, and cosolvent, and the adjusting pH to obtain an emulsion system;

mixing the emulsion system with sodium trimethylsilanolate solution and aqueous inorganic acid solution for first-order reaction, then mixing with water, sodium trimethylsilanolate solution in tetrahydrofuran (THF), and organic fatty acid in petroleum ether for second-order reaction, followed by extraction and drying sequentially, to obtain the silica aerogel powder.

The present invention further provides an application of the above-described silica aerogel powder or a silica aerogel powder prepared by the above-described preparation method in the preparation of insulating materials.

The present invention provides a silica aerogel powder, where the powder is prepared from the following components: 100 to 300 parts by weight of aqueous solution of silica source, 200 to 400 parts by weight of oil phase solvent, 4 to 40 parts by weight of cosolvent, 0.2 to 2 parts by weight of surfactant, 10 to 60 parts by weight of sodium methylsiliconate solution, 1 to 5 parts by weight of aqueous inorganic acid solution, 3 to 10 parts by weight of sodium trimethylsilanolate solution in tetrahydrofuran (THF), and 0.3 to 0.9 part by weight of organic fatty acid in petroleum ether. In the present invention, the resulting emulsion is modified by adding sodium methylsiliconate solution, sodium trimethylsilanolate solution in THF, and organic fatty acid in petroleum ether; both skeleton strength and hydrophobicity of the modified silica aerogel are continuously strengthened; the silica aerogel powder is structurally uniform and features good hydrophobicity, low thermal conductivity, and low density. Embodiments show that for the silica aerogel powder prepared in the present invention, density is 50-90 kg/m³, thermal conductivity is 0.020-0.045 W/m·K, and contact angle is up to 130-155°.

Further, the preparation method provided by the present invention is applicable to achieve industrial production due to simple process, convenient operation, diverse sources of raw materials, low cost, ability to dry under normal pressure, fast preparation of structurally uniform silica aerogel powder with good hydrophobicity, low thermal conductivity, and low density, and ability to better address defects of high cost and long production cycle present in the preparation of silica aerogel in the prior art.

### BRIEF DESCRIPTION OF THE DRAWINGS

The present invention will be further described in detail with reference to the accompanying drawings and specific embodiments.

FIG. 1 shows an infrared spectrogram of a silica aerogel powder prepared in Embodiment 1;

FIG. 2 shows an XRD spectrum of a silica aerogel powder prepared in Embodiment 1;

FIG. 3 shows an SEM image of a silica aerogel powder prepared in Embodiment 1.

### DETAILED DESCRIPTION

The present invention provides a silica aerogel powder, where the powder is prepared from the following components:

100 to 300 parts by weight of aqueous solution of silica source, 200 to 400 parts by weight of oil phase solvent, 4 to 40 parts by weight of cosolvent, 0.2 to 2 parts by weight of surfactant, 10 to 60 parts by weight of sodium methylsiliconate solution, 1 to 5 parts by weight of aqueous inorganic acid solution, 3 to 10 parts by weight of sodium trimethylsilanolate solution in tetrahydrofuran (THF), and 0.3 to 0.9 part by weight of organic fatty acid in petroleum ether, and further preferably 150 to 250 parts by weight of aqueous solution of silica source, 250 to 350 parts by weight of oil phase solvent, 15 to 30 parts by weight of cosolvent, 0.5 to 1.6 parts by weight of surfactant, 30 to 50 parts by weight of sodium methylsiliconate solution, 2 to 4 parts by weight of aqueous inorganic acid solution, 5 to 8 parts by weight of sodium trimethylsilanolate solution in THF, and 0.5 to 0.7 part by weight of organic fatty acid in petroleum ether, and more preferably 200 parts by weight of aqueous solution of silica source, 300 parts by weight of oil phase solvent, 20 parts by weight of cosolvent, 1.5 parts by weight of surfactant, 40 parts by weight of sodium methylsiliconate solution, 3.5 parts by weight of aqueous inorganic acid solution, 5 parts by weight of sodium trimethylsilanolate solution in THF, and 0.6 part by weight of organic fatty acid in petroleum ether.

In the present invention, all raw materials used in the present invention are commercially available products in the art, unless otherwise specified.

In the present invention, a mass concentration of SiO2 in the aqueous solution of silica source is preferably 5%-8%, further preferably 6%-7%, and more preferably 6.5%; a silica source in the aqueous solution of silica source preferably includes alkaline silica sol, acidic silica sol, water glass, or orthosilicate-hydrolyzed silica sol; when the silica source in the aqueous solution of silica source is an orthosilicate-hydrolyzed silica sol, the orthosilicate-hydrolyzed silica sol preferably includes tetramethoxysilane, orthosilicate, or tetrapropyl orthosilicate. Using a certain amount of aqueous solution of silica source at a certain mass concentration in the present invention can form a uniform nano-porous structure of silica aerogel and ensure the resulting silica aerogel has good thermal conductivity in a high-strength skeleton structure.

In the present invention, the oil phase solvent includes hydrocarbon solvent, halohydrocarbon solvent, or ester solvent, and further preferably hydrocarbon solvent; when the oil phase solvent is a hydrocarbon solvent, the hydrocarbon solvent preferably includes benzene, toluene, xylene, hexane, octane, cyclohexane, cyclohexanone, toluene-cyclohexanone, liquid paraffin, or kerosene; when the oil phase solvent is a halohydrocarbon solvent, the halohydrocarbon solvent preferably includes chlorobenzene, dichlorobenzene, or dichloromethane; when the oil phase solvent is an ester solvent, the ester solvent preferably includes methyl acetate, ethyl acetate, or propyl acetate.

In the present invention, the cosolvent is preferably an alcohol, and further preferably isopropanol or butanol.

In the present invention, the surfactant preferably includes cationic surfactant and/or nonionic surfactant; when the surfactant is preferably a mixture of cationic surfactant with nonionic surfactant, the mass ratio of cationic surfactant to nonionic surfactant is preferably 1:3 to 3:1. In the present invention, the cationic surfactant preferably includes one or more of C₁₂₋₁₈ alkyl trimethyl ammonium bromides, and the nonionic surfactant preferably includes one or more kinds of sorbitan fatty acid esters, fatty acid monoglycerides, and fatty acid diglycerides, and further preferably Span-80 in embodiments of the present invention.

In the present invention, the mass concentration of the sodium methylsiliconate solution is preferably 28%-32%, and further preferably 30%. Modification of the resulting silica aerogel with a certain amount of sodium methylsiliconate solution at a certain mass concentration in the present invention can not only improve the uniformity of pore structure of the silica aerogel effectively, but also ensure efficient oil-water separation in the subsequent preparation process.

In the present invention, the aqueous inorganic acid solution preferably includes hydrochloric, nitric, sulfuric, phosphoric, or hydrofluoric acid; the molar concentration of the aqueous inorganic acid solution is 0.01-0.015 mol/L, and further preferably 0.012 mol/L. Using a certain amount of aqueous inorganic acid solution at a certain molar concentration in the present invention can accelerate the hydrolysis rate of sodium methylsiliconate effectively, promote the modification of the resulting silica aerogel with sodium methylsiliconate solution, and improve the uniformity of pore structure of the silica aerogel effectively.

In the present invention, the mass concentration of the sodium trimethylsilanolate solution in THF is preferably 8%-12%, and further preferably 10%. Modification of the resulting silica aerogel with a certain amount of sodium trimethylsilanolate solution in THF at a certain mass concentration in the present invention can improve the uniformity of pore structure of the silica aerogel effectively.

In the present invention, the molar concentration of the organic fatty acid in petroleum ether is preferably 0.01-0.015 mol/L, and further preferably 0.012 mol/L; the organic fatty acid from the organic fatty acid in petroleum ether includes one or more of C₈₋₁₈ fatty acids. C₈₋₁₈ organic fatty acids used in the present invention can react with sodium trimethylsilanolate to produce sodium fatty acid; the resulting sodium fatty acid can serve as a surfactant with good water compatibility, which can transfer from the oil phase of a colloidal particle to the aqueous phase, and thus improve the uniformity of pore structure of the silica aerogel effectively. Using a certain amount of aqueous inorganic acid solution at a certain molar concentration in the present invention can accelerate the hydrolysis rate of sodium methylsiliconate effectively, promote the modification of the resulting silica aerogel with sodium methylsiliconate solution, and improve the uniformity of pore structure of the silica aerogel effectively.

The present invention further provides a preparation method of the silica aerogel powder in the foregoing technical solution, including the following steps:

mixing and heating aqueous solution of silica source, surfactant, oil phase solvent, and cosolvent, and the adjusting pH to obtain an emulsion system;

mixing the emulsion system with sodium trimethylsilanolate solution and aqueous inorganic acid solution for first-order reaction, then mixing with water, sodium trimethylsilanolate solution in tetrahydrofuran (THF), and organic fatty acid in petroleum ether for second-order reaction, followed by extraction and drying sequentially, to obtain the silica aerogel powder.

In the present invention, the aqueous solution of silica source, the surfactant, the oil phase solvent, and the cosolvent are mixed and heated, followed by adjusting pH, and an emulsion system is obtained. In the present invention, the heating temperature is preferably 50-60° C., and further preferably 55° C. In the present invention, the mixing method is preferably magnetic stirring; the magnetic stirring time is preferably 8-12 min, and further preferably 10 min; the stirring rate is preferably 350-450 rmp, and further preferably 400 rmp. The order of the mixing is not specifically limited in the present invention, and any mixing order may be used.

In the present invention, the pH value is preferably adjusted to 6 to 7; a regulator for adjusting the pH value is preferably aqueous ammonia or hydrochloric acid solution; the aqueous ammonia is preferably obtained by diluting aqueous ammonia at a mass concentration of 25% to 28% with 50-fold water; the hydrochloric acid solution is preferably obtained by diluting hydrochloric acid at a mass concentration of 36% to 38% with 50-fold water. In the present invention, a dropping rate of the regulator is preferably 2 drops per second. The consumption of the regulator is not specifically limited in the present invention as long as it is satisfactory to adjust the pH value to 6 to 7. After adjusting pH, the present invention preferably allows the resulting product to stand for 24 h, produce gel particles, and thus obtain an emulsion system; the gel particles produced at this point are micron-sized, fine gel particles encapsulated by oil phase on the surface. The gel particles prepared by the present invention can reduce the diffusion distance and time that sodium methylsiliconate solution, aqueous inorganic acid solution, sodium trimethylsilanolate solution in THF, and organic fatty acid in petroleum ether are added in gel particles subsequently.

After the emulsion system is obtained, the present invention mixes the emulsion system, the sodium methylsiliconate solution, and the aqueous inorganic acid solution for first-order reaction, then mixes with water, sodium trimethylsilanolate solution in THF, and organic fatty acid in petroleum ether for second-order reaction, followed by extraction and drying sequentially, to obtain the silica aerogel powder. In the present invention, the mixing method is preferably magnetic stirring; the stirring rate is preferably 300-400 rmp, and further preferably 350 rmp.

In the present invention, the sodium methylsiliconate solution is preferably added dropwise to the emulsion system. In the present invention, the dropping rate is preferably 1-2 drops per second. In the present invention, stop adding the sodium methylsiliconate solution and keep stirring for 1-5 min to diffuse sodium methylsiliconate into gel particles, until the pH value of the emulsion system is preferably at 7.8 to 8.2; the present invention preferably adds the aqueous inorganic acid solution dropwise to the emulsion system. In the present invention, the dropping rate is preferably 1-2 drops per second. The consumption of the aqueous inorganic acid solution is not specifically limited in the present invention as long as it is satisfactory to adjust the pH value of the emulsion system to 7. The present invention preferably repeats the steps of adding the sodium methylsiliconate solution and the aqueous inorganic acid solution dropwise sequentially, until 10 to 60 parts by weight of sodium methylsiliconate solution and 1 to 5 parts by weight of aqueous inorganic acid solution are dropped fully. In the present invention, adding the sodium methylsiliconate solution dropwise to the emulsion system first is to diffuse hydrophilic sodium methylsiliconate into gel particles rapidly; after sodium methylsiliconate is diffused uniformly, sodium methylsiliconate is concerted into methylsilanol to further modify gel particles in situ and strengthen the internal and superficial hydrophobicity of gel particles by adding the aqueous inorganic acid solution to control the pH value of the emulsion system at 7; steps of repeatedly adding the sodium methylsiliconate solution and the aqueous inorganic acid solution dropwise is to enable methylsilanol to modify gel particles more thoroughly and thus improve modification effect of sodium methylsiliconate on gel particles.

After the first-order reaction is completed, the present invention preferably mixes the products obtained from the first-order reaction with water and then reacts with sodium trimethylsilanolate solution in THF and organic fatty acid in petroleum ether for second-order reaction. The consumption of the water is not specifically limited in the present invention as long as phase inversion can occur in the emulsion system. The present invention preferably identify whether there is phase inversion in the emulsion system by means of adding a water-based pigment into the emulsion system; when the emulsion system shows a natural color of the water-based pigment, it indicates that phase inversion occurs in the emulsion system. In the present invention, the water is preferably deionized water. In the present invention, the dropping rate of the water is preferably 1 drop per second. In the present invention, both the sodium trimethylsilanolate solution in THF and the organic fatty acid in petroleum ether are preferably added dropwise into the emulsion system at the same time; the dropping rate of both the sodium trimethylsilanolate solution in THF and the organic fatty acid in petroleum ether is independently and preferably 1-2 drops per second. In the present invention, phase inversion occurs in the emulsion system after adding water dropwise into the emulsion system, thereby producing silica gel beads encapsulated by aqueous phase on the surface, which are strongly hydrophobic; meanwhile, oil phase partly enters into the silica gel beads, creating favorable conditions for subsequent diffusion of sodium trimethylsilanolate; after adding sodium trimethylsilanolate solution in THF dropwise, sodium trimethylsilanolate will diffuse into the silica gel beads uniformly; after adding organic fatty acid in petroleum ether dropwise, the organic fatty acid from the petroleum ether diffuses into the silica gel beads and reacts with sodium trimethylsilanolate to produce trimethylsilanol to further modify the silica gel beads, while the resulting fatty acid sodium migrates to the surface of silica gel beads, promoting subsequent oil-water separation.

After the second-order reaction is completed, the present invention preferably adjusts the pH value of the resulting second-order reaction products, and the pH value is preferably adjusted to 7. In the present invention, the regulator for adjusting the pH value is preferably aqueous ammonia or hydrochloric acid solution; the source of the aqueous ammonia or the hydrochloric acid solution is consistent with that of the foregoing aqueous ammonia or hydrochloric acid solution and will not be repeated herein. The consumption of the regulator for adjusting the pH value is not specifically limited in the present invention as long as it is satisfactory to adjust the pH value of the emulsion system to 7. After adjusting the pH value, the present invention preferably extracts and dries the pH-adjusted products sequentially to obtain the silica aerogel powder. In the present invention, extraction is preferably conducted after adding deionized water to have oil-water separation appear in the emulsion system. In the present invention, the extracted supernatant suspensoid is preferably dried; the drying is preferably conducted under normal pressure, the drying temperature is preferably 70-100° C., and further preferably 80° C. The extraction method is not specifically limited in the present invention as long as the extraction method is well known to those skilled in the art. The silica aerogel powder prepared by the present invention is strongly hydrophobic, without removing impurities; treated by extraction, impurities in silica aerogel powders are migrated to the aqueous phase, and therefore the drying can be conducted under normal pressure.

The present invention further provides an application of the silica aerogel powder of the foregoing technical solution or the silica aerogel powder prepared by the preparation method of the foregoing technical solution in the preparation of insulating materials.

In the present invention, the silica aerogel powder is preferably used as filler of insulating materials. How the silica aerogel powder is used as filler of insulating materials is not specifically limited in the present invention, as long as application methods are well known to those skilled in the art.

The silica aerogel powder of the present invention, the preparation method and the application thereof will be described in detail below with reference to embodiments, but they should not be construed as limiting the scope of the invention.

### Embodiment 1

1) Heat 100 parts by weight of acidic silica sol with 5% SiO₂, 0.2 part by weight of surfactant cetyltrimethylammonium bromide (CTAB), 200 parts by weight of oil phase kerosene, and 4 parts by weight of cosolvent n-butanol at 50° C., and stir in a magnetic stirrer at 400 rmp for 10 min;

2) Add dilute aqueous ammonia dropwise into an emulsion, stir and adjust the pH value to 6 to 7, gelatinize the solution gradually after standing for a period of time, and let the emulsion stand for 24 h; the aqueous ammonia is obtained by diluting aqueous ammonia at a mass concentration of 28% with 50-fold water;

3) Stir the emulsion system at 300 rmp, and then slowly add 30% sodium methylsiliconate solution dropwise for modification; once the emulsion system is measured at pH=8, stop adding the sodium methylsiliconate solution dropwise;

4) Keep stirring at 300 rmp; once sodium methylsiliconate is diffused uniformly into gel particles, add dilute hydrochloric acid solution to adjust the emulsion system at a pH of 7; the hydrochloric acid solution is obtained by diluting hydrochloric acid at a mass concentration of 37% with 50-fold water;

5) As such, add 10 parts by weight of sodium methylsiliconate solution and 1 part by weight of 0.1 mol/L nitric acid solution dropwise repeatedly;

6) While stirring at 300 rmp, once phase inversion occurs in the emulsion by adding an appropriate amount of deionized water dropwise, add 3 parts by weight of 10% sodium trimethylsilanolate solution in tetrahydrofuran (THF) and 0.3 part by weight of 0.01 mol/L C₁₈ organic fatty acid in petroleum ether dropwise, and adjust the emulsion system at a pH of 7; and

7) Add an appropriate amount of deionized water, let oil-water separation appear in the emulsion system further, and take and dry supernatant suspensoids in an oven at 100° C. for 2 h under normal pressure to obtain hydrophobic silica aerogel powders.

Determine the resulting silica aerogel powders, and list the result obtained in Table 1.

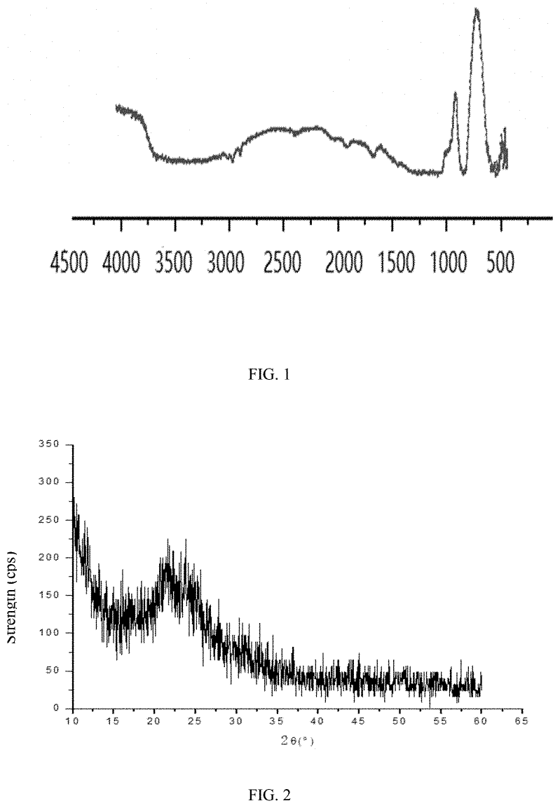

FIG. 1 shows an infrared spectrogram of a silica aerogel powder prepared in Embodiment 1. As seen from FIG. 1, when the amount of cetyltrimethylammonium bromide (CTAB) is 0.2 part by weight, absorption peak at 800 cm⁻¹ is a Si—O—Si bond, C—H bonds fall within around 2900 cm⁻¹, and there is no significant change in functional group. As can be seen, the main spatial structure of the product is Si—O—Si.

FIG. 2 shows an XRD spectrum of a silica aerogel powder prepared in Embodiment 1. As seen from FIG. 2, the silica aerogel powder prepared shows no significant diffraction peak. Thus, the sample prepared is structurally amorphous.

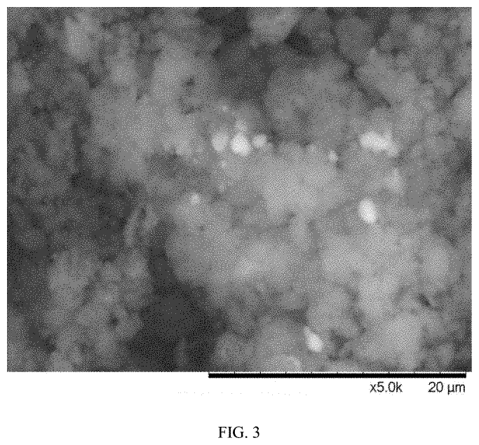

FIG. 3 shows an SEM image of a silica aerogel powder prepared in Embodiment 1, indicating that the silica aerogel powder has uniform pores microscopically, with an obvious pore structure.

### Embodiment 2

1) Heat 300 parts by weight of acidic silica sol with 8% SiO₂, 2 parts by weight of surfactant cetyltrimethylammonium bromide (CTAB), 400 parts by weight of oil phase kerosene, and 40 part by weight of cosolvent n-butanol at 50° C., and stir in a magnetic stirrer at 450 rmp for 10 min;

2) Add dilute aqueous ammonia dropwise into an emulsion, stir and adjust the pH value to 6 to 7, gelatinize the solution gradually after standing for a period of time, and let the emulsion stand for 24 h; the aqueous ammonia is obtained by diluting aqueous ammonia at a mass concentration of 28% with 50-fold water;

3) Stir the emulsion system at 300 rmp, and then slowly add 30% sodium methylsiliconate solution dropwise for modification; once the emulsion system is measured at pH=8, stop adding the sodium methylsiliconate solution dropwise;

4) Keep stirring at 300 rmp; once sodium methylsiliconate is diffused uniformly into gel particles, add dilute hydrochloric acid solution to adjust the emulsion system at a pH of 7; the hydrochloric acid solution is obtained by diluting hydrochloric acid at a mass concentration of 37% with 50-fold water;

5) As such, add 60 parts by weight of sodium methylsiliconate solution and 5 parts by weight of 0.1 mol/L phosphoric acid solution dropwise repeatedly;

6) While stirring at 300 rmp, once phase inversion occurs in the emulsion by adding an appropriate amount of deionized water dropwise, add 10 parts by weight of 10% sodium trimethylsilanolate solution in tetrahydrofuran (THF) and 0.9 part by weight of 0.01 mol/L C8 organic fatty acid in petroleum ether dropwise, and adjust the emulsion system at a pH of 7; and

7) Add an appropriate amount of deionized water, let oil-water separation appear in the emulsion system further, and take and dry supernatant suspensoids in an oven at 100° C. for 2 h under normal pressure to obtain hydrophobic silica aerogel powders.

Determine the resulting silica aerogel powders, and list the result obtained in Table 1.

### Embodiment 3

1) Heat 200 parts by weight of acidic silica sol with 6% SiO2, 1.5 parts by weight of surfactant cetyltrimethylammonium bromide (CTAB), 0.5 part by weight of Span-80, 300 parts by weight of oil phase kerosene, and 20 part by weight of cosolvent n-butanol at 50° C., and stir in a magnetic stirrer at 450 rmp for 10 min;

2) Add dilute aqueous ammonia dropwise into an emulsion, stir and adjust the pH value to 6 to 7, gelatinize the solution gradually after standing for a period of time, and let the emulsion stand for 24 h; the aqueous ammonia is obtained by diluting aqueous ammonia at a mass concentration of 28% with 50-fold water;

3) Stir the emulsion system at 300 rmp, and then slowly add 30% sodium methylsiliconate solution dropwise for modification; once the emulsion system is measured at pH=8, stop adding the sodium methylsiliconate solution dropwise;

4) Keep stirring at 300 rmp; once sodium methylsiliconate is diffused uniformly in gel particles, add dilute hydrochloric acid solution to adjust the emulsion system at a pH of 7; the hydrochloric acid solution is obtained by diluting hydrochloric acid at a mass concentration of 37% with 50-fold water;

5) As such, add 40 parts by weight of sodium methylsiliconate solution and 3.5 parts by weight of 0.1 mol/L hydrochloric acid solution dropwise repeatedly;

6) While stirring at 300 rmp, once phase inversion occurs in the emulsion by adding an appropriate amount of deionized water dropwise, add 5 parts by weight of 10% sodium trimethylsilanolate solution in tetrahydrofuran (THF) and 0.6 part by weight of 0.01 mol/L C12 organic fatty acid in petroleum ether dropwise, and adjust the emulsion system at a pH of 7; and

7) Add an appropriate amount of deionized water, let oil-water separation appear in the emulsion system further, and take and dry supernatant suspensoids in an oven at 100° C. for 2 h under normal pressure to obtain hydrophobic silica aerogel powders.

Determine the resulting silica aerogel powders, and list the result obtained in Table 1.

### Embodiment 4

The embodiment has the same conditions as Embodiment 3, but the only difference is that the mass concentration of SiO₂ in the aqueous solution of silica source is 14% in the embodiment.

Determine the resulting silica aerogel powders, and list the result obtained in Table 1.

TABLE 1
Performance test results of silica aerogel
powders prepared in Embodiments 1 to 4

| | Embodi- | Embodi- | Embodi- | Embodi- |
|---|---|---|---|---|
| Performance | ment 1 | ment 2 | ment 3 | ment 4 |
| Density, | 50 | 90 | 60 | 78 |
| kg/m³ | | | | |
| Thermal | 0.031 | 0.027 | 0.020 | 0.045 |
| conductivity, | | | | |
| W/m · k | | | | |
| Contact | 130 | 155 | 150 | 145 |
| angle, ° | | | | |

As seen from Table 1, the density, thermal insulation performance and hydrophobicity of the silica aerogel powder provided by the present invention exhibit excellent performance; for the silica aerogel powder, the density is 50-90 kg/m³, thermal conductivity is 0.020-0.045 W/m·K, and contact angle is up to 130-155°.

The foregoing descriptions are only preferred implementation manners of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. A silica aerogel powder, wherein the powder is prepared from the following components:
100 to 300 parts by weight of aqueous solution of silica source, 200 to 400 parts by weight of oil phase solvent, 4 to 40 parts by weight of cosolvent, 0.2 to 2 parts by weight of surfactant, 10 to 60 parts by weight of sodium methylsiliconate solution, 1 to 5 parts by weight of aqueous inorganic acid solution, 3 to 10 parts by weight of sodium trimethylsilanolate solution in tetrahydrofuran (THF), and 0.3 to 0.9 part by weight of organic fatty acid in petroleum ether.

2. The silica aerogel powder according to claim 1, wherein a mass concentration of the sodium methylsiliconate solution is 28%-32%.

3. The silica aerogel powder according to claim 1, wherein a mass concentration of the sodium trimethylsilanolate solution in THF is 8%-12%.

4. The silica aerogel powder according to claim 1, wherein a molar concentration of the organic fatty acid in petroleum ether is 0.01-0.015 mol/L.

5. The silica aerogel powder according to claim 1, wherein the organic fatty acid from the organic fatty acid in petroleum ether comprises one or more of C₈₋₁₈ fatty acids.

6. The silica aerogel powder according to claim 4, wherein the organic fatty acid from the organic fatty acid in petroleum ether comprises one or more of C₈₋₁₈ fatty acids.

7. The silica aerogel powder according to claim 1, wherein a mass concentration of SiO₂ in the aqueous solution of silica source is 5%-8%.

8. The silica aerogel powder according to claim 1, wherein a molar concentration of the aqueous inorganic acid solution is 0.01-0.015 mol/L.

9. The silica aerogel powder according to claim 1, wherein the oil phase solvent comprises hydrocarbon solvent, halohydrocarbon, or esters.

10. A preparation method of the silica aerogel powder according to claim 1, comprising the following steps:
mixing and heating aqueous solution of silica source, surfactant, oil phase solvent, and cosolvent, and the adjusting pH to obtain an emulsion system;
mixing the emulsion system with sodium trimethylsilanolate solution and aqueous inorganic acid solution for first-order reaction, then mixing with water, sodium trimethylsilanolate solution in tetrahydrofuran (THF), and organic fatty acid in petroleum ether for second-order reaction, followed by extraction and drying sequentially, to obtain the silica aerogel powder.

11. A preparation method of the silica aerogel powder according to claim 2, comprising the following steps:
mixing and heating aqueous solution of silica source, surfactant, oil phase solvent, and cosolvent, and the adjusting pH to obtain an emulsion system;
mixing the emulsion system with sodium trimethylsilanolate solution and aqueous inorganic acid solution for first-order reaction, then mixing with water, sodium trimethylsilanolate solution in tetrahydrofuran (THF), and organic fatty acid in petroleum ether for second-order reaction, followed by extraction and drying sequentially, to obtain the silica aerogel powder.

12. A preparation method of the silica aerogel powder according to claim 3, comprising the following steps:
mixing and heating aqueous solution of silica source, surfactant, oil phase solvent, and cosolvent, and the adjusting pH to obtain an emulsion system;
mixing the emulsion system with sodium trimethylsilanolate solution and aqueous inorganic acid solution for first-order reaction, then mixing with water, sodium trimethylsilanolate solution in tetrahydrofuran (THF), and organic fatty acid in petroleum ether for second-order reaction, followed by extraction and drying sequentially, to obtain the silica aerogel powder.

13. A preparation method of the silica aerogel powder according to claim 4, comprising the following steps:
mixing and heating aqueous solution of silica source, surfactant, oil phase solvent, and cosolvent, and the adjusting pH to obtain an emulsion system;
mixing the emulsion system with sodium trimethylsilanolate solution and aqueous inorganic acid solution for first-order reaction, then mixing with water, sodium trimethylsilanolate solution in tetrahydrofuran (THF), and organic fatty acid in petroleum ether for second-order reaction, followed by extraction and drying sequentially, to obtain the silica aerogel powder.

14. A preparation method of the silica aerogel powder according to claim 5, comprising the following steps:
mixing and heating aqueous solution of silica source, surfactant, oil phase solvent, and cosolvent, and the adjusting pH to obtain an emulsion system;
mixing the emulsion system with sodium trimethylsilanolate solution and aqueous inorganic acid solution for first-order reaction, then mixing with water, sodium trimethylsilanolate solution in tetrahydrofuran (THF), and organic fatty acid in petroleum ether for second-order reaction, followed by extraction and drying sequentially, to obtain the silica aerogel powder.

15. A preparation method of the silica aerogel powder according to claim 6, comprising the following steps:
mixing and heating aqueous solution of silica source, surfactant, oil phase solvent, and cosolvent, and the adjusting pH to obtain an emulsion system;
mixing the emulsion system with sodium trimethylsilanolate solution and aqueous inorganic acid solution for first-order reaction, then mixing with water, sodium trimethylsilanolate solution in tetrahydrofuran (THF), and organic fatty acid in petroleum ether for second-order reaction, followed by extraction and drying sequentially, to obtain the silica aerogel powder.

16. A preparation method of the silica aerogel powder according to claim 7, comprising the following steps:
mixing and heating aqueous solution of silica source, surfactant, oil phase solvent, and cosolvent, and the adjusting pH to obtain an emulsion system;
mixing the emulsion system with sodium trimethylsilanolate solution and aqueous inorganic acid solution for first-order reaction, then mixing with water, sodium trimethylsilanolate solution in tetrahydrofuran (THF), and organic fatty acid in petroleum ether for second-order reaction, followed by extraction and drying sequentially, to obtain the silica aerogel powder.

17. A preparation method of the silica aerogel powder according to claim 8, comprising the following steps:
mixing and heating aqueous solution of silica source, surfactant, oil phase solvent, and cosolvent, and the adjusting pH to obtain an emulsion system;
mixing the emulsion system with sodium trimethylsilanolate solution and aqueous inorganic acid solution for first-order reaction, then mixing with water, sodium trimethylsilanolate solution in tetrahydrofuran (THF), and organic fatty acid in petroleum ether for second-order reaction, followed by extraction and drying sequentially, to obtain the silica aerogel powder.

18. A preparation method of the silica aerogel powder according to claim 9, comprising the following steps:
mixing and heating aqueous solution of silica source, surfactant, oil phase solvent, and cosolvent, and the adjusting pH to obtain an emulsion system;
mixing the emulsion system with sodium trimethylsilanolate solution and aqueous inorganic acid solution for first-order reaction, then mixing with water, sodium trimethylsilanolate solution in tetrahydrofuran (THF), and organic fatty acid in petroleum ether for second-order reaction, followed by extraction and drying sequentially, to obtain the silica aerogel powder.

19. An application of the silica aerogel powder according to claim 1 in the preparation of insulating materials.

20. An application of a silica aerogel powder prepared by the preparation method according to claim 10 in the preparation of insulating materials.
